(19) United States
(12) Patent Application Publication
(10) Pub. No.: US 2020/0055390 A1
(43) Pub. Date: Feb. 20, 2020

(54) LIQUID TRAP DRAIN PUMP

(71) Applicant: Eaton Intelligent Power Limited, Dublin (IE)

(72) Inventors: Robert P. Benjey, Dexter, MI (US); Jeffrey B. Smith, Rochester Hills, MI (US); Daniel Pifer, Chelsea, MI (US); Robert A. Dayton, Attica, MI (US)

(73) Assignee: Eaton Intelligent Power Limited, Dublin (IE)

(21) Appl. No.: 16/665,661

(22) Filed: Oct. 28, 2019

Related U.S. Application Data
(63) Continuation of application No. PCT/US2018/029869, filed on Apr. 27, 2018.
(60) Provisional application No. 62/491,523, filed on Apr. 28, 2017.
(60) Provisional application No. 62/635,884, filed on Feb. 27, 2018.

(51) Int. Cl. B60K 15/077; B60K 15/035

(52) U.S. Cl. CPC B60K 15/077; B60K 2015/03243; B60K 15/03504

(57) ABSTRACT

A pump assembly for a liquid trap of a vehicle fuel tank assembly includes a pump configured to couple to the liquid trap and selectively drain liquid therefrom, a sensor configured to monitor an inductive signature of the pump, and a controller programmed to operate the pump and monitor the inductive signature to determine if liquid is present in the liquid trap based on the monitored inductive signature.

### CROSS REFERENCE TO RELATED APPLICATION

This application is a continuation of International Application No. PCT/US2018/029869 filed Apr. 27, 2018, which claims the benefit of U.S. Provisional Application No. 62/491,523, filed Apr. 28, 2017, and U.S. Provisional Application No. 62/635,884, filed Feb. 27, 2018, the contents of which are incorporated herein by reference thereto.

### FIELD

The present disclosure relates generally to fuel tank systems for a vehicle and, more particularly, to a liquid trap system for a vehicle fuel tank system.

### BACKGROUND

Fuel vapor emission control systems are becoming increasingly more complex, in large part in order to comply with environmental and safety regulations imposed on manufacturers of gasoline powered vehicles. Along with the ensuing overall system complexity, complexity of individual components within the system has also increased. Certain regulations affecting the gasoline-powered vehicle industry require that fuel vapor emission from a fuel tank's ventilation system be stored during periods of an engine's operation. In order for the overall vapor emission control system to continue to function for its intended purpose, periodic purging of stored hydrocarbon vapors is necessary during operation of the vehicle. In fuel tanks configured for use with a hybrid powertrain it is also necessary to properly vent the fuel tank. Such fuel tanks need to account for high pressures and can incorporate an over pressure relief (OPR) and over vacuum relief (OVR). Moreover, it may also be necessary to provide a means for OVR in a conventional gasoline fuel tank system.

Such fuel vapor management systems typically include a carbon filled canister to adsorb unburned fuel vapors, and a conduit system for directing fuel vapors to the carbon filled canister or to an engine intake for combustion therein. Additionally, the fuel vapor management systems may include an on-board diagnostic capability for detecting leaks within the system. In addition to managing the vapor emission, some fuel systems include liquid traps that are configured to operate as part of a venturi pump pressure reducer. The venturi pump is typically configured to run constantly, thereby resulting in unwanted parasitic loss. While such known systems function well for their intended purposes, it is desirable to provide improved fuel vapor management systems.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

In one example aspect, a pump assembly for a liquid trap of a vehicle fuel tank assembly is provided. The pump assembly includes a pump configured to couple to the liquid trap and selectively drain liquid therefrom, a sensor configured to monitor an inductive signature of the pump, and a controller programmed to operate the pump and monitor the inductive signature to determine if liquid is present in the liquid trap based on the monitored inductive signature.

In addition to the foregoing, the described pump assembly may include one or more of the following features: wherein the controller is further programmed to operate the pump if the monitored inductive signature indicates a presence of liquid in the liquid trap, and shut off the pump if the monitored inductive signature indicates an absence of liquid in the trap; wherein the controller is further programmed to periodically turn on the pump and monitor the inductive signature of the pump; and wherein the pump is a solenoid pump.

In another example aspect, a method of operating a vehicle fuel vapor management system having a fuel tank and a liquid trap is provided. The method includes operating a pump operably coupled to the liquid trap and configured to drain liquid from the liquid trap to the fuel tank, monitoring an inductive signature of the operating pump, the inductive signature indicating a presence or absence of liquid in the liquid trap, and selectively turning the pump on and off based on the monitored inductive signature.

In addition to the foregoing, the described method may include one or more of the following features: operating the pump if the inductive signature is a first measured inductive signature indicative of a presence of liquid in the liquid trap, and shutting off the pump when the inductive signature is a second measured inductive signature indicative of an absence of liquid in the liquid trap, wherein the second measured inductive signature is different than the first measured inductive signature; and wherein the first measured inductive signature includes an inflection that occurs at a first time that is greater than a predetermined time threshold, and wherein the second measured inductive signature includes an inflection that occurs at a second time that is less than the predetermined time threshold.

In addition to the foregoing, the described method may include one or more of the following features: periodically turning on the pump at predetermined time intervals to monitor the inductive signature to determine if liquid is present in the liquid trap; monitoring parameters of the vehicle, identifying parameters that tend to result in a presence of liquid in the liquid trap, and turning on the pump when the parameters occur; and wherein the parameters include the vehicle undergoing a high acceleration event and when a fuel level in the tank exceeds a predetermined level.

In another example aspect, a fuel vapor management system for a vehicle is provided. In one example, the system includes a fuel tank, a liquid trap configured to separate liquid and vapor fuel in the fuel tank, and a pump assembly configured to pump liquid from the liquid trap and drain the liquid to the fuel tank. The pump assembly includes a pump operably coupled to the liquid trap, a sensor configured to monitor an inductive signature of the pump, and a controller programmed to operate the pump and monitor the inductive signature to determine if liquid is present in the liquid trap based on the monitored inductive signature.

In addition to the foregoing, the described fuel vapor management system may include one or more of the following features: wherein the controller is further programmed to operate the pump if the monitored inductive signature indicates a presence of liquid in the liquid trap, and shut off the pump if the monitored inductive signature indicates an absence of liquid in the trap; wherein the controller is further programmed to periodically turn on the pump and monitor the inductive signature of the pump; and an evaporative emissions control system configured to recapture and recycle emitted fuel vapor on the fuel tank, the evaporative emissions control system comprising at least one vent tube disposed in the fuel tank, at least one vent valve disposed on the at least one vent tube that is configured to selectively open and close at least one port fluidly coupled to the at least one vent tube, a vent shut-off assembly that selectively opens and closes the at least one valve to provide overpressure and vacuum relief for the fuel tank, and a control module that regulates operation of the vent shut-off assembly based on operating conditions.

In addition to the foregoing, the described fuel vapor management system may include one or more of the following features: an evaporative emissions control system configured to recapture and recycle emitted fuel vapor on the fuel tank, the evaporative emissions control system comprising a first vent tube disposed in the fuel tank, a second vent tube disposed in the fuel tank, a first vent valve disposed on the first vent tube that is configured to selectively open and close a first port fluidly coupled to the first vent tube, a second vent valve disposed on the second vent tube that is configured to selectively open and close a second port fluidly coupled to the second vent tube, a vent shut-off assembly that selectively opens and closes the first and second valves to provide overpressure and vacuum relief for the fuel tank, and a control module that regulates operation of the vent shut-off assembly based on operating conditions.

In addition to the foregoing, the described fuel vapor management system may include one or more of the following features: wherein the vent shut-off assembly comprises a cam assembly having a cam shaft that includes a first cam and a second cam; wherein, the first and second cams have respective profiles that correspond to at least a fully opened valve position, a fully closed valve position, and a partially open valve position; and wherein the first and second vent valves are caused to selectively open and close based on rotation of the respective first and second cams to deliver fuel vapor through the respective first and second vent tubes.

In addition to the foregoing, the described fuel vapor management system may include one or more of the following features: an actuator assembly that drives the cam assembly, the actuator assembly including a motor; wherein the motor comprises a direct current motor that rotates a worm gear that in turn drives a drive gear coupled to the cam shaft; and an evaporative emissions control system configured to recapture and recycle emitted fuel vapor, the evaporative emissions control system comprising at least one vent valve configured to selectively open and close at least one vent, a pressure sensor configured to sense a pressure in the fuel tank, and a control module configured to regulate operation of the at least one vent valve to provide over-pressure and vacuum relief for the fuel tank, the control module programmed to periodically monitor the pressure in the fuel tank, wherein future control of the at least one vent valve is based on differences in the measured fuel tank pressure and the liquid level.

In addition to the foregoing, the described fuel vapor management system may include one or more of the following features: an evaporative emissions control system configured to recapture and recycle emitted fuel vapor, the evaporative emissions control system comprising a first vent valve configured to selectively open and close a first vent, a second vent valve configured to selectively open and close a second vent, a pressure sensor configured to sense a pressure in the fuel tank, and a control module configured to regulate operation of the first and second vent valves to provide over-pressure and vacuum relief for the fuel tank, the control module programmed to periodically monitor the pressure in the fuel tank, wherein future control of the first and second vent valves is based on differences in the measured fuel tank pressure and the liquid level.

### BRIEF DESCRIPTION OF THE DRAWINGS

The present disclosure will become more fully understood from the detailed description and the accompanying drawings, wherein:

FIG. 1 is a schematic illustration of a fuel tank system having an evaporative emissions control system including a vent shut-off assembly, a controller, an electrical connector and associated wiring in accordance to one example of the present disclosure;

FIG. 2 is a front perspective view of an evaporative emissions control system including a vent shut-off assembly configured with solenoids according to one example of the present disclosure;

FIG. 3 is an exploded view of the evaporative emissions control system of FIG. 2;

FIG. 4 is a perspective view of a fuel tank system having a vent shut-off assembly and configured for use on a saddle fuel tank according to another example of the present disclosure and shown with the fuel tank in section view;

FIG. 5 is a perspective view of the vent shut-off assembly of the fuel tank system of FIG. 4;

FIG. 6 is a top perspective view of a vent shut-off assembly constructed in accordance to additional features of the present disclosure;

FIG. 7 is a bottom perspective view of the vent shut-off assembly of FIG. 6;

FIG. 8 is a sectional view of the vent shut-off assembly of FIG. 6 taken along lines 8-8;

FIG. 9 is a sectional view of the vent shut-off assembly of FIG. 6 taken along lines 9-9;

FIG. 10 is a front perspective view of a vent shut-off assembly constructed in accordance to another example of the present disclosure;

FIG. 11 is a sectional view of the vent shut-off assembly of FIG. 10 taken along lines 11-11;

FIG. 12 is a sectional view of the vent shut-off assembly of FIG. 10 taken along lines 12-12;

FIG. 13 is an exploded view of the vent shut-off assembly of FIG. 10;

FIG. 14 is a cross-sectional view of a vent shut-off assembly constructed in accordance to additional features of the present disclosure and incorporating a plunger configured to drain liquid fuel;

FIG. 15 is a sectional view taken along lines A-A of FIG. 14; and

FIG. 16 is a sectional view taken along lines B-B of FIG. 15;

FIG. 17 is a schematic view of an example fuel vapor management system constructed in accordance to additional features of the present disclosure and incorporating a pump configured to drain liquid fuel; and

FIG. 18 is a graph illustrating an example current signature of the pump shown in FIG. 18.

### DETAILED DESCRIPTION

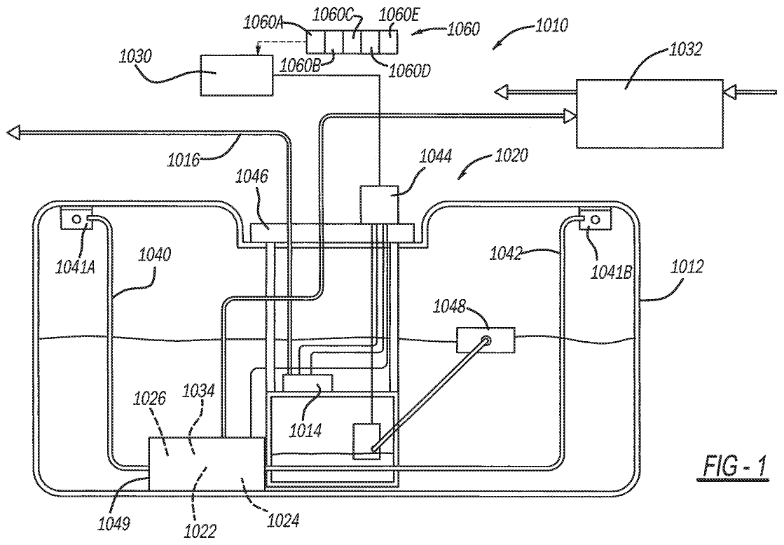

With initial reference to FIG. 1, a fuel tank system constructed in accordance to one example of the present disclosure is shown and generally identified at reference number 1010. The fuel tank system 1010 can generally include a fuel tank 1012 configured as a reservoir for holding fuel to be supplied to an internal combustion engine via a fuel delivery system, which includes a fuel pump 1014. The fuel pump 1014 can be configured to deliver fuel through a fuel supply line 1016 to a vehicle engine. An evaporative emissions control system 1020 can be configured to recapture and recycle the emitted fuel vapor. As will become appreciated from the following discussion, the evaporative emissions control system 1020 provides an electronically controlled module that manages the complete evaporative system for a vehicle.

The evaporative emissions control system 1020 provides a universal design for all regions and all fuels. In this regard, the requirement of unique components needed to satisfy regional regulations may be avoided. Instead, software may be adjusted to satisfy wide-ranging applications. In this regard, no unique components need to be revalidated saving time and cost. A common architecture may be used across vehicle lines. Conventional mechanical in-tank valves may be replaced. As discussed herein, the evaporative control system 1020 may also be compatible with pressurized systems including those associated with hybrid powertrain vehicles.

The evaporative emissions control system 1020 includes a vent shut-off assembly 1022, a manifold assembly 1024, a liquid trap 1026, a control module 1030, a purge canister 1032, an energy storage device 1034, a first vapor tube 1040, a second vapor tube 1042, an electrical connector 1044, a fuel delivery module (FDM) flange 1046 and a float level sensor assembly 1048. The first vapor tube 1040 can terminate at a vent opening 1041A that may include a baffle arranged at a top corner of the fuel tank 1012. Similarly, the second vapor tube 1042 can terminate at a vent opening 1041B that may include a baffle arranged at a top corner of the fuel tank 1012.

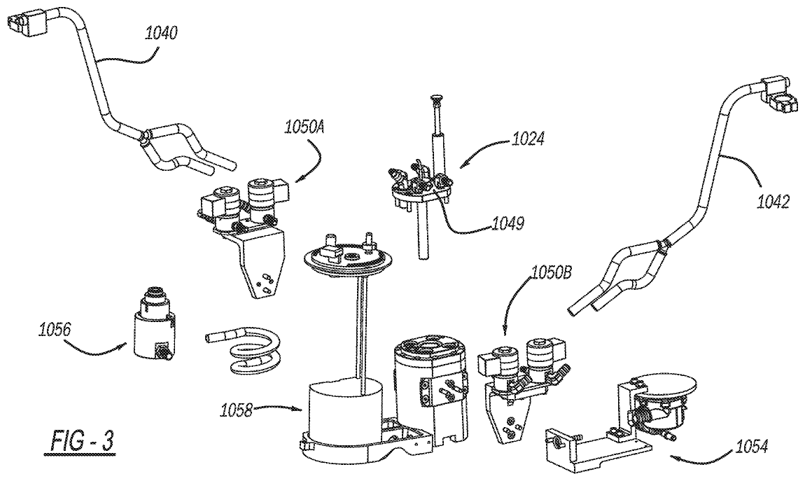

In one example, the manifold assembly 1024 can include a manifold body 1049 (FIG. 3) that routes venting to an appropriate vent tube 1040 and 1042 (or other vent tubes) based on operating conditions. As will become appreciated from the following discussion, the vent shut-off assembly 1022 can take many forms such as electrical systems including solenoids and mechanical systems including DC motor actuated cam systems.

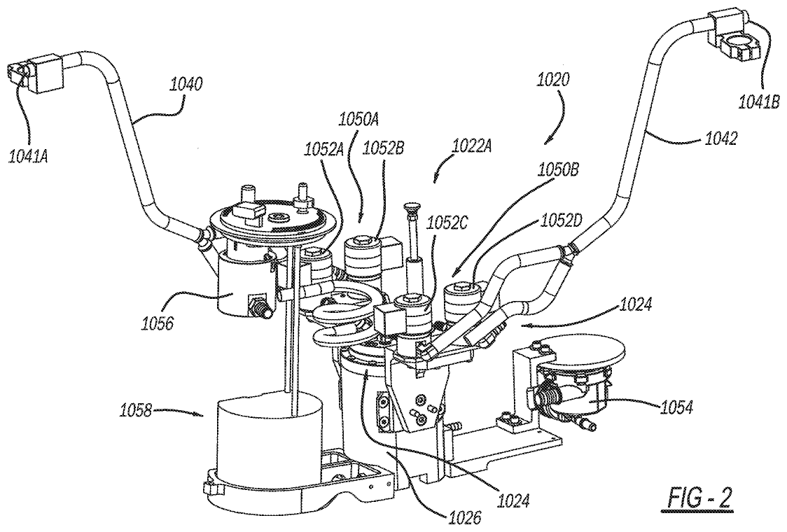

Turning now to FIGS. 2 and 3, a vent shut-off assembly 1022A constructed in accordance to one example of the present disclosure is shown. As can be appreciated, the vent shut-off assembly 1022A can be used as part of an evaporative emissions control system 1020 in the fuel tank system 1010 described above with respect to FIG. 1. The vent shut-off assembly 1022A includes two pair of solenoid banks 1050A and 1050B. The first solenoid bank 1050A includes first and second solenoids 1052A and 1052B. The second solenoid bank 1050B includes third and fourth solenoids 1052C and 1052D.

The first and second solenoids 1052A and 1052B can be fluidly connected to the vapor tube 1040. The third and fourth solenoids 1052C and 1052D can be fluidly connected to the vapor tube 1042. The control module 1030 can be adapted to regulate the operation of the first, second, third and fourth solenoids 1052A, 1052B, 1052C and 1052D to selectively open and close pathways in the manifold assembly 1024, in order to provide over-pressure and vacuum relief for the fuel tank 1012. The evaporative emissions control assembly 1020 can additionally comprise a pump 1054, such as a venturi pump and a safety rollover valve 1056. A conventional sending unit 1058 is also shown.

The control module 1030 can further include or receive inputs from system sensors, collectively referred to at reference 1060. The system sensors 1060 can include a tank pressure sensor 1060A that senses a pressure of the fuel tank 1012, a canister pressure sensor 10608 that senses a pressure of the canister 1032, a temperature sensor 1060C that senses a temperature within the fuel tank 1012, a tank pressure sensor 1060D that senses a pressure in the fuel tank 1012 and a vehicle grade sensor and or vehicle accelerometer 1060E that measures a grade and/or acceleration of the vehicle. It will be appreciated that while the system sensors 1060 are shown as a group, that they may be located all around the fuel tank system 1010.

The control module 1030 can additionally include fill level signal reading processing, fuel pressure driver module functionality and be compatible for two-way communications with a vehicle electronic control module (not specifically shown). The vent shut-off assembly 1022 and manifold assembly 1024 can be configured to control a flow of fuel vapor between the fuel tank 1012 and the purge canister 1032. The purge canister 1032 adapted to collect fuel vapor emitted by the fuel tank 1012 and to subsequently release the fuel vapor to the engine. The control module 1030 can also be configured to regulate the operation of evaporative emissions control system 1020 in order to recapture and recycle the emitted fuel vapor. The float level sensor assembly 1048 can provide fill level indications to the control module 1030.

When the evaporative emissions control system 1020 is configured with the vent shut-off assembly 1022A, the control module 1030 can close individual solenoids 1052A-1052D or any combination of solenoids 1052A-1052D to vent the fuel tank system 1010. For example, the solenoid 1052A can be actuated to close the vent 1040 when the float level sensor assembly 1048 provides a signal indicative of a full fuel level state. While the control module 1030 is shown in the figures generally remotely located relative to the solenoid banks 1050A and 1050B, the control module 1030 may be located elsewhere in the evaporative emissions control system 1020 such as adjacent the canister 1032 for example.

With continued reference to FIGS. 1-3, additional features of the evaporative emissions control system 1020 will be described. In one configuration, the vent tubes 1040 and 1042 can be secured to the fuel tank 1012 with clips. The inner diameter of the vent tubes 1040 and 1042 can be 3-4 mm. In some examples, the poppet valve assembly or cam lobes will determine smaller orifice sizes. The vent tubes 1040 and 1042 can be routed to high points of the fuel tank 1012. In other examples, external lines and tubes may additionally or alternatively be utilized. In such examples, the external lines are connected through the tank wall using suitable connectors such as, but not limited to, welded nipple and push-through connectors.

As identified above, the evaporative emissions control system 1020 can replace conventional fuel tank systems that require mechanical components including in-tank valves with an electronically controlled module that manages the complete evaporative system for a vehicle. In this regard, some components that may be eliminated using the evaporative emissions control system 1020 of the instant disclosure can include in-tank valves such as GVV's and FLVV's, canister vent valve solenoid and associated wiring, tank pressure sensors and associated wiring, fuel pump driver module and associated wiring, fuel pump module electrical connector and associated wiring, and vapor management valve(s) (system dependent). These eliminated components are replaced by the control module 1030, vent shut-off assembly 1022, manifold 1024, solenoid banks 1050A, 1050B and associated electrical connector 1044. Various other components may be modified to accommodate the evaporative emissions control system 1020 including the fuel tank 1012. For example, the fuel tank 1012 may be modified to eliminate valves and internal lines to pick-up points. The flange of the FDM 1046 may be modified to accommodate other components such as the control module 1030 and/or the electrical connector 1044. In other configurations, the fresh air line of the canister 1032 and a dust box may be modified. In one example, the fresh air line of the canister 1032 and the dust box may be connected to the control module 1030.

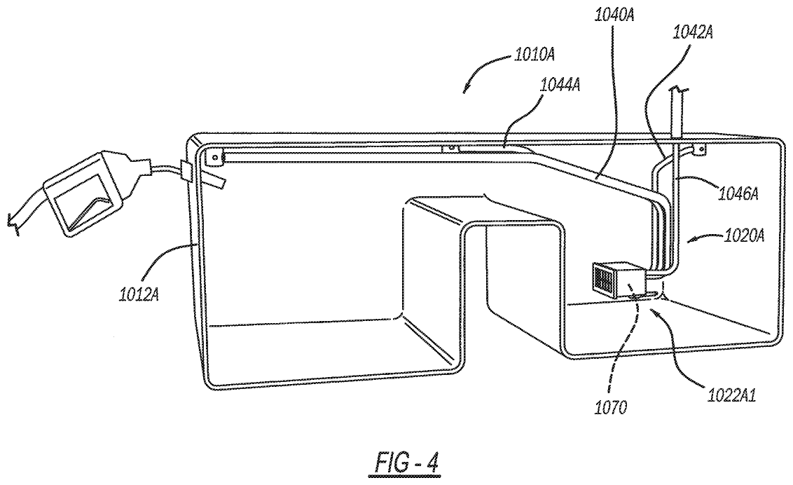

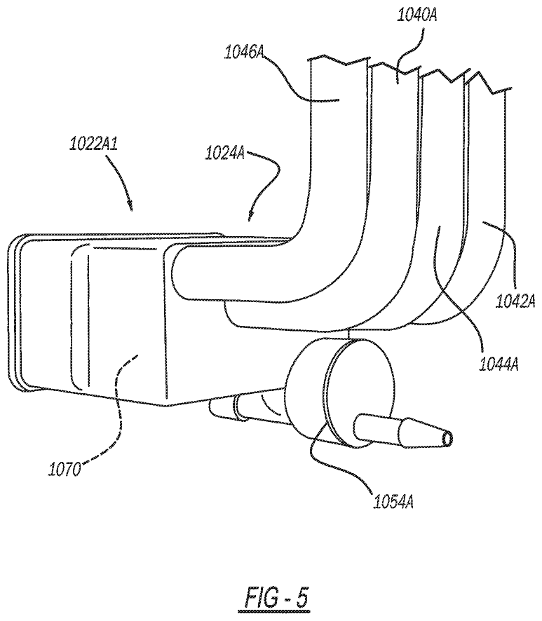

Turning now to FIGS. 4 and 5, a fuel tank system 1010A constructed in accordance to another example of the present disclosure will be described. Unless otherwise described, the fuel tank system 1010A can include an evaporative emissions control system 1020A that incorporate features described above with respect to the fuel tank system 1010. The fuel tank system 1010A is incorporated on a saddle type fuel tank 1012A. A vent shut-off assembly 1022A1 can include a single actuator 1070 that communicates with a manifold 1024A to control opening and closing of three or more vent point inlets. In the example shown, the manifold assembly 1024A routs to a first vent 1040A, a second vent line 1042A and a third vent line 1044A. A vent 1046A routs to the canister (see canister 1032, FIG. 1). A liquid trap and a drain 1054A are incorporated on the manifold assembly 1024A. The fuel tank system 1010A can perform fuel tank isolation for high pressure hybrid applications without requiring a fuel tank isolation valve (FTIV). Further, the evaporative emissions control system 1020A can achieve the highest possible shut-off at the vent points. The system is not inhibited by conventional mechanical valve shut-off or reopening configurations. Vapor space and overall tank height may be reduced.

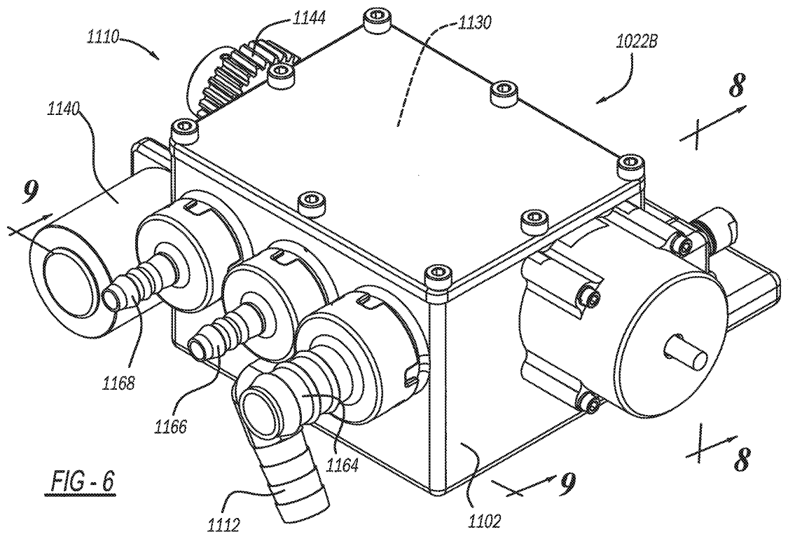

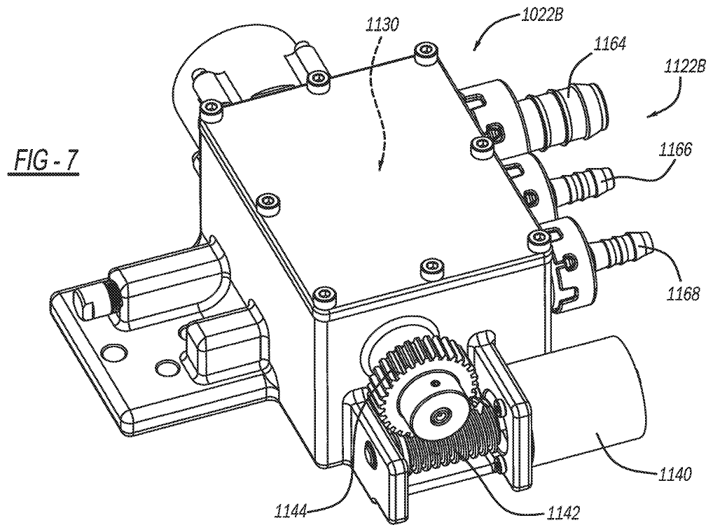

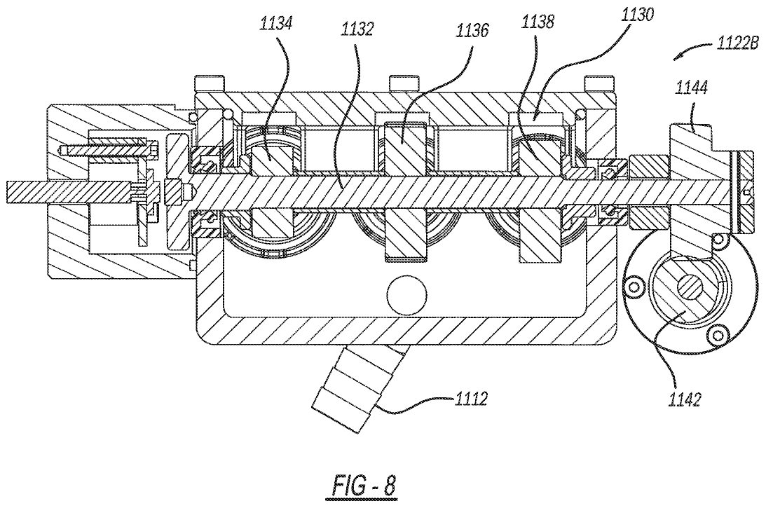

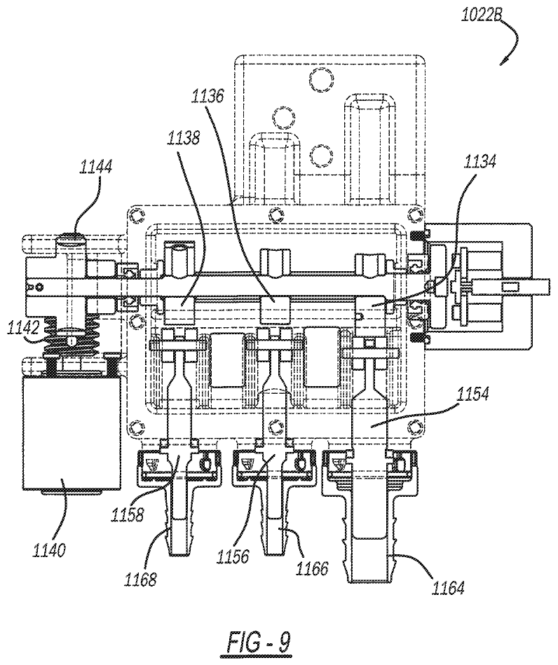

Turning now to FIGS. 6-9, a vent shut-off assembly 1022B constructed in accordance to another example of the present disclosure will be described. The vent shut-off assembly 10228 includes a main housing 1102 that at least partially houses an actuator assembly 1110. A canister vent line 1112 routs to the canister (see canister 1032, FIG. 1). The actuator assembly 1110 can generally be used in place of the solenoids described above to open and close selected vent lines. The vent shut-off assembly 1022B includes a cam assembly 1130. The cam assembly 1130 includes a cam shaft 1132 that includes cams 1134, 1136 and 1138. The cam shaft 1132 is rotatably driven by a motor 1140. In the example shown the motor 1140 is a direct current motor that rotates a worm gear 1142 that in turn drives a drive gear 1144. The motor 1140 is mounted outboard of the main housing 1102. Other configurations are contemplated. The cams 1134, 1136 and 1138 rotate to open and close valves 1154, 1156 and 1158, respectively. The valves 1154, 1156 and 1158 open and close to selectively deliver vapor through ports 1164, 1166 and 1168, respectively. In one example the motor 1140 can alternately be a stepper motor. In other configurations, a dedicated DC motor may be used for each valve. Each DC motor may have a home function. The DC motors can include a stepper motor, a bi-directional motor, a uni-directional motor a brushed motor and a brushless motor. The home function can include a hard stop, electrical or software implementation, trip switches, hard stop (cam shaft), a potentiometer and a rheostat.

In one configuration the ports 1164 and 1166 can be routed to the front and back of the fuel tank 1012. The port 1164 can be configured solely as a refueling port. In operation, if the vehicle is parked on a grade where the port 1166 is routed to a low position in the fuel tank 1012, the cam 1134 is rotated to a position to close the port 1164. During refueling, the valve 1154 associated with port 1164 is opened by the cam 1134. Once the fuel level sensor 1048 reaches a predetermined level corresponding to a “Fill” position, the controller 1030 will close the valve 1154. In other configurations, the cam 1134, valve 1154 and port 1164 can be eliminated leaving two cams 1136 and 1138 that open and close valves 1156 and 1158. In such an example, the two ports 1168 and 1166 can be 7.5 mm orifices. If both ports 1168 and 1166 are open, refueling can occur. If less flow is required, a cam position can be attained where one of the valves 1156 and 1158 are not opened all the way.

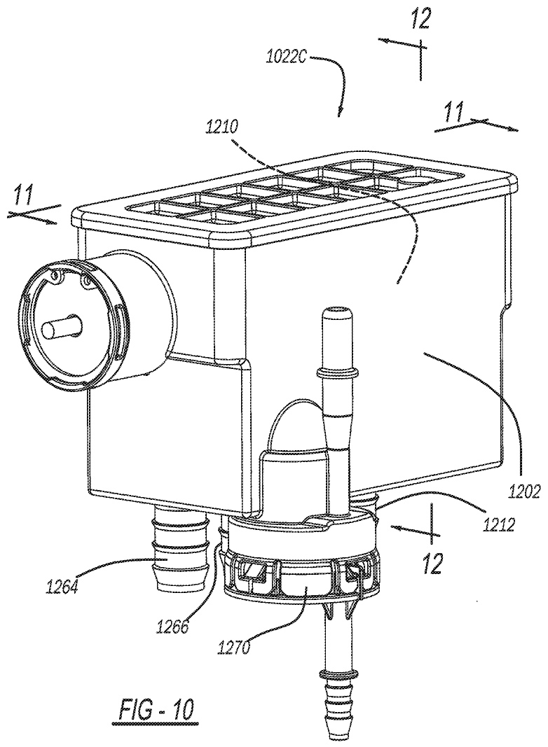

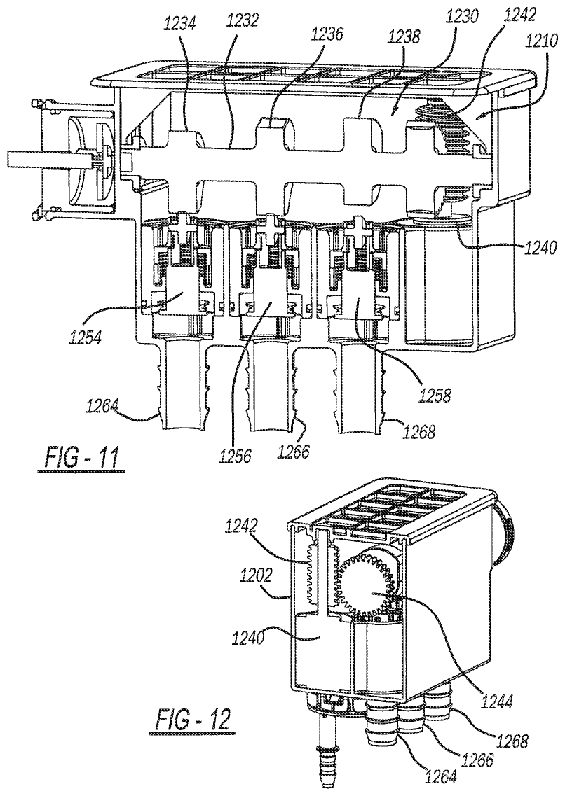

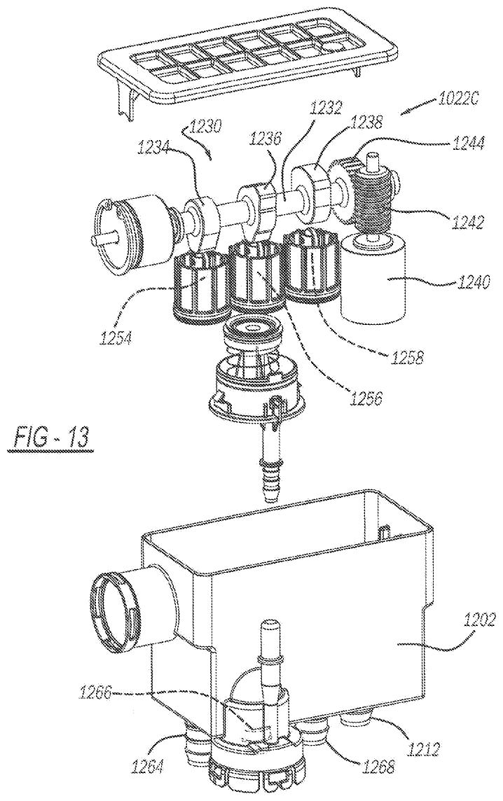

Turning now to FIGS. 10-13, a vent shut-off assembly 1022C constructed in accordance to another example of the present disclosure will be described. The vent shut-off assembly 1022C includes a main housing 1202 that at least partially houses an actuator assembly 1210. A canister vent line 1212 routs to the canister (see canister 1032, FIG. 1). The actuator assembly 1210 can generally be used in place of the solenoids described above to open and close selected vent lines. The vent shut-off assembly 1022C includes a cam assembly 1230. The cam assembly 1230 includes a cam shaft 1232 that includes cams 1234, 1236 and 1238. The cam shaft 1232 is rotatably driven by a motor 1240. In the example shown the motor 1240 is received in the housing 1202. The motor 1240 is a direct current motor that rotates a worm gear 1242 that in turn drives a drive gear 1244. Other configurations are contemplated. The cams 1234, 1236 and 1238 rotate to open and close valves 1254, 1256 and 1258, respectively. The valves 1254, 1256 and 1258 open and close to selectively deliver vapor through ports 1264, 1266 and 1268, respectively. In one example the motor 1240 can alternately be a stepper motor. A drain 1270 can be provided on the housing 1202.

In one configuration the ports 1264 and 1266 can be routed to the front and back of the fuel tank 1012. The port 1264 can be configured solely as a refueling port. In operation, if the vehicle is parked on a grade where the port 1266 is routed to a low position in the fuel tank 1012, the cam 1236 is rotated to a position to close the port 1266. During refueling, the valve 1254 associated with port 1264 is opened by the cam 1234. Once the fuel level sensor 1048 reaches a predetermined level corresponding to a “Fill” position, the controller 1030 will close the valve 1254. In other configurations, the cam 1234, valve 1254 and port 1264 can be eliminated leaving two cams 1236 and 1238 that open and close valves 1256 and 1258. In such an example, the two ports 1268 and 1266 can be 7.5 mm orifices. If both ports 1268 and 1266 are open, refueling can occur. If less flow is required, a cam position can be attained where one of the valves 1256 and 1258 are not opened all the way.

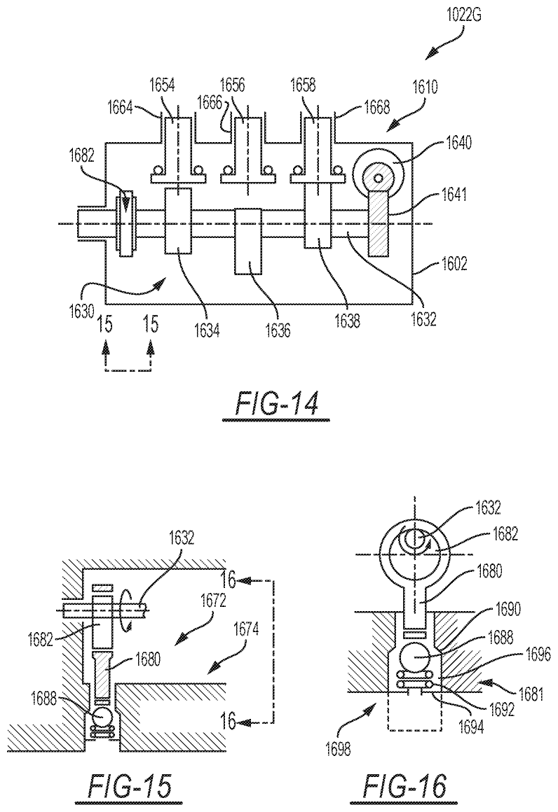

Turning now to FIG. 14, a vent shut-off assembly constructed in accordance to additional features of the present disclosure is shown and generally identified at reference 1022G. The vent shut-off assembly 1022G includes a main housing 1602 that at least partially houses an actuator assembly 1610. A canister vent line (not shown) can rout to the canister (see canister 1032, FIG. 1). The actuator assembly 1610 can open and close selected vent lines. The vent shut-off assembly 1022G includes a cam assembly 1630. The cam assembly 1630 includes a primary drive shaft 1632 having cams 1634, 1636 and 1638 disposed thereon.

The primary drive shaft 1632 is rotatably driven by a motor or gear motor 1640. In the example shown, the motor 1640 is received in the housing 1602. While the motor 1640 is shown having a drive gear 1641 for rotating primary drive shaft 1632, other gearing arrangements are contemplated. The cams 1634, 1636 and 1638 rotate to open and close valves 1654, 1656 and 1658, respectively. The valves 1654, 1656 and 1658 open and close to selectively deliver vapor through ports 1664, 1666 and 1668, respectively.

The vent shut-off assembly 1022G further includes a drain pump or plunger assembly 1672. The plunger assembly 1672 can drain liquid fuel that has entered the main housing 1602 at a liquid trap 1674. As will become appreciated, the vent shut-off assembly 1022G combines functionality in that the actuator assembly 1610 including the motor 1640 and the camshaft 1632 and can be used to open and close selected vents and also drain the liquid trap 1674. In some prior art arrangements, pumping liquid fuel out of the liquid trap requires an electric pump or supplemental venturi pump. The vent shut-off assembly 1022G utilizes the motor 1640 and camshaft 1632 as the energy source which reduces the number of components and complexity of the liquid trap.

With particular reference now to FIGS. 15 and 16, the plunger assembly 1672 will be further described. The plunger assembly 1672 includes a plunger 1680 that opens and closes a check valve assembly 1681 based on rotation of the cam shaft 1632. A cam plunger lobe 1682 influences linear reciprocal motion of the plunger 1680 based on rotation of the cam shaft 1632.

The check valve assembly 1681 includes a check ball 1688 that is urged against a seat 1690 by a biasing member 1692. A retainer 1694 captures the biasing member 1692 and check ball 1688 within a pocket 1696 on the housing 1602. A barb 1698 can be used to add a hose to transport rejected liquid fuel to a specified place in the fuel tank. As the cam shaft 1632 rotates during the normal venting process, the lobe 1682 drives the plunger 1680 on the bottom of the sump that pushes liquid fuel out of the housing 1602 with each camshaft rotation, thus eliminating liquid carry-over.

It will be appreciated that some or all of the pump examples described herein may be configured to additionally or alternatively pump vapor. Pumping vapor may be useful to a customer for various reasons. In some examples it may be useful to conduct pressure decay leak check for OBD of the fuel tank. Further, it will be appreciated that the pump configurations described herein may be combined for use with other vent port valve configurations beyond what is shown in the Figures and described above. In other words, the pump may be operated by a single driver (motor, etc.) that is also operating vents in the vent shut-off assembly of the fuel system.

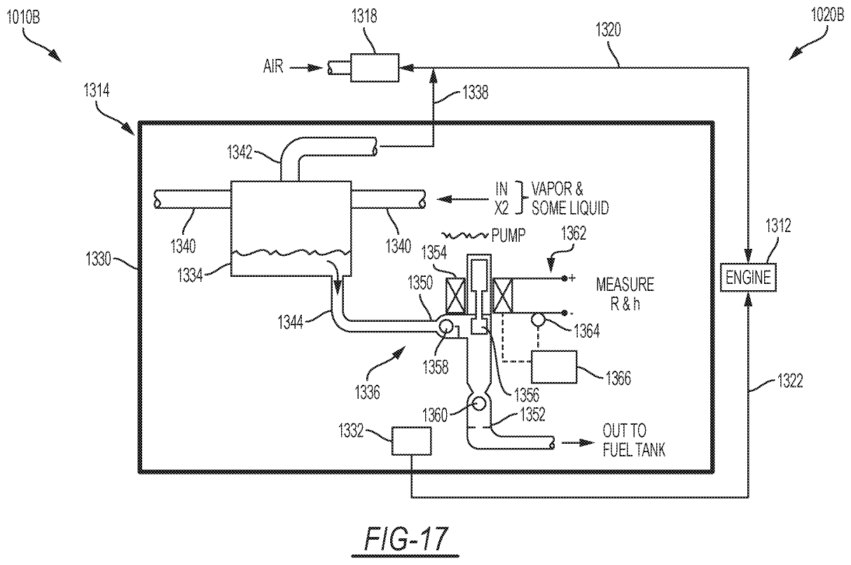

Turning now to FIG. 17, the present teachings further disclose an active drain liquid trap for fuel systems. The active drain liquid trap disclosed herein is configured to only periodically operate when liquid is present in the liquid trap, rather than continually. In this regard, the present teachings provide more efficient strategies for evacuating liquid from the liquid trap while offering energy savings.

With initial reference to FIG. 17, a fuel tank system 10108 constructed in accordance with another example of the present disclosure will be disclosed. Unless otherwise described, the fuel tank system 10108 can include an evaporative emissions control system or fuel vapor management system 1020B that incorporates features describe above with respect to the fuel tank systems 1010 and 1010A. However, the fuel vapor management system 10208 may be utilized with various other vehicles or systems. For example, one or more portions of system 10208 may be utilized with or incorporated into the systems described herein.

In the example embodiment, the fuel vapor management system 10208 can be operably coupled to an internal combustion engine 1312 and can generally include a fuel tank assembly 1314, a fuel vapor storage canister 1318, a purge or vapor fuel line 1320, and a liquid fuel line 1322.

In the illustrated example, the fuel tank assembly 1314 can include a fuel tank 1330 having a fuel pump assembly 1332, a liquid trap 1334, and a pump assembly or solenoid pump 1336. The fuel pump assembly 1332 may include one or more pumps for pressurizing and supplying fuel to fuel injectors (not shown) of the engine 1312. Fuel vapors generated in fuel tank 1330, for example during refueling, may be directed to the storage canister 1318 via a conduit 1338. During a purging operation, the fuel vapors stored in the storage canister 1318 may subsequently be purged to an intake manifold of engine 1312 via the vapor fuel line 1320.

The liquid trap 1334 can include a vent line or fluid inlet conduit 1340, a vapor outlet conduit 1342, and a liquid drain outlet 1344. The liquid trap 1334 can be configured to separate liquid and vapor fuel entering the fluid inlet conduit 1340, and the separated liquid is subsequently drained back to the fuel tank 1330 via the drain outlet 1344. The separated vapor is subsequently directed through the vapor outlet conduit 1342 to the conduit 1338 for removal from the fuel tank 1330.

The solenoid pump 1336 is configured to drain the liquid trap 1334 and can generally include a pump inlet 1350, a pump outlet 1352, windings 1354, and a reciprocating piston 1356. Pump inlet 1350 is fluidly connected to liquid trap drain outlet 1344 and includes a check valve 1358 configured to prevent liquid driving back to the liquid trap 1334. Pump outlet 1352 is fluidly connected to the fuel tank 1330 and includes a check valve 1360 configured to prevent liquid in the fuel tank 1330 from driving back into the solenoid pump 1336.

Windings 1354 are connected to an electrical terminal 1362. Powering the solenoid pump 1336 causes piston 1356 to reciprocate and draw fluid from the liquid trap 1334. A sensor 1364 is coupled to solenoid pump 1336, for example at electrical terminal 1362, and is configured to measure the resistance and/or inductance of the solenoid pump 1336 based on the electrical parameters of the pump 1336.

A controller 1366 can be in signal communication with the solenoid pump 1336 and sensor 1364. Controller 1366 can be configured to selectively turn the solenoid pump 1336 on and off (e.g., selectively energize) to perform a reciprocating motion of piston 1356 to pump and drain liquid from the liquid trap 1334. As used herein, the term controller refers to an application specific integrated circuit (ASIC), an electronic circuit, a processor (shared, dedicated, or group) and memory that executes one or more software or firmware programs, a combinational logic circuit, and/or other suitable components that provide the described functionality.

In the example embodiment, controller 1366 selectively energizes solenoid pump 1336 and monitors sensor 1364 to determine an inductive signature of the solenoid pump 1336. For example, when no liquid is present in the liquid trap 1334, piston 1356 reciprocates at a relatively fast speed due to an absence of liquid resistance, and pump 1336 produces a first inductive signature. When liquid is present in the liquid trap 1334, piston 1356 reciprocates at a relatively slower speed due to liquid resistance, and pump 1336 produces a second inductive signature. Accordingly, controller 1366 can operate the solenoid pump 1336 for a short predetermined period of time to detect the first or second inductive signature.

When the first inductive signature is detected, controller 1366 can determine liquid is not present in the liquid trap 1334 and turn off pump 1336 to conserve power and prolong the useful life of solenoid pump 1336. Controller 1366 may conduct a periodic watch cycle that turns on the solenoid pump 1336 at predetermined time intervals to measure the inductive signature and check if there is any liquid in the liquid trap 1334 that needs to be drained. When the second inductive signature is detected, controller 1366 can determine liquid is in the liquid trap 1334. Controller 1366 can subsequently operate the solenoid pump 1336 to drain the liquid until the first inductive signature is detected.

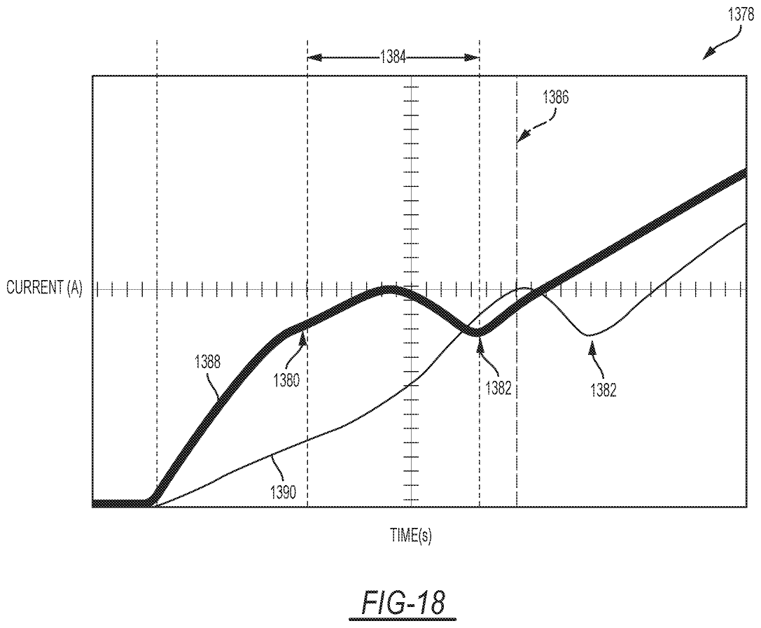

FIG. 18 illustrates an example of a solenoid inductive current signature 1378 (current vs. time) of the solenoid pump 1336 during operation. When a voltage is applied across windings 1354, the windings 1354 energize and the current therethrough increases as shown on the graph. During this time, current builds in the windings 1354 until the current level is high enough to generate sufficient magnetic force to move the piston 1356. The current signature reflects this change via a first inflection point 1380. The piston 1356 then moves from a fully retracted position to a fully extended position.

At this fully extended position of the piston 1356, the current signature experiences a dip or inflection 1382 that reflects a full stroke of the piston 1356. Thus, a portion 1384 reflects the time it takes the piston 1356 to move from the fully retracted position to the fully extended position. Piston 1356 may then be returned to the fully retracted position by reversing the current or with a return spring or other device (not shown).

The elapsed travel time provides valuable information that can be used in various applications. For example, the travel time may be compared to a predetermined threshold 1386. If the inflection 1382 occurs prior to the predetermined threshold 86 (see line 1388), controller 1366 determines that piston 1356 is moving relatively quickly and thus there is no liquid in the liquid trap 1334 (i.e., piston 1356 is reciprocating in air). If the inflection point occurs after the predetermined threshold 1386 (see line 1390), controller determines that piston 1356 is moving relatively slower due to the presence of liquid and thus there is liquid in the liquid trap 1334.

Additionally, controller 1366 can be configured to monitor various parameters of the vehicle simultaneously with the liquid level in the liquid trap 1334. Accordingly, controller 1366 can subsequently identify conditions, parameters, events, or occurrences that tend to result in or have a correlation to liquid buildup in the liquid trap 1334. Controller 1366 can then be configured to turn on solenoid pump 1336 when such conditions occur. As such, controller 1366 can “learn” or diagnose which conditions cause or are likely to cause liquid to build up in liquid trap 1334 to thereby quickly drain the liquid trap 1334 in between the predetermined time intervals of the periodic watch cycle. For example, controller 1366 may identify that liquid builds up in the liquid trap 1334 when fuel tank 1330 has a high fuel level (above a predetermined level) or after the vehicle experiences high acceleration events. Accordingly, controller 1366 subsequently turns on solenoid pump 1336 when the fuel level exceeds the predetermined level and/or after the vehicle experiences a high acceleration event, to thereby drain any liquid buildup.

Described herein are systems and methods for draining liquid traps of a vehicle fuel system. The system periodically operates a solenoid pump and monitors the inductive signature thereof to determine if liquid is present in the liquid trap. If liquid is determined to be present, the pump is operated until the inductive signature indicates an absence of liquid. If liquid is not present, the solenoid pump is turned off until a predetermined time has elapsed or a condition is present indicating a probability that liquid is present. Accordingly, the described system eliminates the need for constantly running pumps, eliminates the need for a liquid level sensor in the liquid trap, and reduces parasitic load on the main fuel pump, thereby reducing cost and complexity.

The foregoing description of the examples has been provided for purposes of illustration and description. It is not intended to be exhaustive or to limit the disclosure. Individual elements or features of a particular example are generally not limited to that particular example, but, where applicable, are interchangeable and can be used in a selected example, even if not specifically shown or described. The same may also be varied in many ways. Such variations are not to be regarded as a departure from the disclosure, and all such modifications are intended to be included within the scope of the disclosure.

What is claimed is:

1. A pump assembly for a liquid trap of a vehicle fuel tank assembly, the pump assembly comprising:
a pump configured to couple to the liquid trap and selectively drain liquid therefrom;
a sensor configured to monitor an inductive signature of the pump; and
a controller programmed to operate the pump and monitor the inductive signature to determine if liquid is present in the liquid trap based on the monitored inductive signature.

2. The pump assembly of claim 1, wherein the controller is further programmed to:
operate the pump if the monitored inductive signature indicates a presence of liquid in the liquid trap; and
shut off the pump if the monitored inductive signature indicates an absence of liquid in the trap.

3. The pump assembly of claim 2, wherein the controller is further programmed to periodically turn on the pump and monitor the inductive signature of the pump.

4. The pump assembly of claim 1, wherein the pump is a solenoid pump.

5. A method of operating a vehicle fuel vapor management system having a fuel tank and a liquid trap, the method comprising:
operating a pump operably coupled to the liquid trap and configured to drain liquid from the liquid trap to the fuel tank;
monitoring an inductive signature of the operating pump, the inductive signature indicating a presence or absence of liquid in the liquid trap; and
selectively turning the pump on and off based on the monitored inductive signature.

6. The method of claim 5, further comprising:
operating the pump if the inductive signature is a first measured inductive signature indicative of a presence of liquid in the liquid trap; and
shutting off the pump when the inductive signature is a second measured inductive signature indicative of an absence of liquid in the liquid trap, wherein the second measured inductive signature is different than the first measured inductive signature.

7. The method of claim 6, wherein the first measured inductive signature includes an inflection that occurs at a first time that is greater than a predetermined time threshold, and wherein the second measured inductive signature includes an inflection that occurs at a second time that is less than the predetermined time threshold.

8. The method of claim 6, further comprising periodically turning on the pump at predetermined time intervals to monitor the inductive signature to determine if liquid is present in the liquid trap.

9. The method of claim 8, further comprising:
monitoring parameters of the vehicle;
identifying parameters that tend to result in a presence of liquid in the liquid trap; and
turning on the pump when the parameters occur.

10. The method of claim 7, wherein the parameters include the vehicle undergoing a high acceleration event and when a fuel level in the tank exceeds a predetermined level.

11. A fuel vapor management system for a vehicle, comprising:
a fuel tank;
a liquid trap configured to separate liquid and vapor fuel in the fuel tank; and
a pump assembly configured to pump liquid from the liquid trap and drain the liquid to the fuel tank, the pump assembly comprising:
a pump operably coupled to the liquid trap;
a sensor configured to monitor an inductive signature of the pump; and
a controller programmed to operate the pump and monitor the inductive signature to determine if liquid is present in the liquid trap based on the monitored inductive signature.

12. The fuel vapor management system of claim 11, wherein the controller is further programmed to:
operate the pump if the monitored inductive signature indicates a presence of liquid in the liquid trap; and
shut off the pump if the monitored inductive signature indicates an absence of liquid in the trap.

13. The fuel vapor management system of claim 12, wherein the controller is further programmed to periodically turn on the pump and monitor the inductive signature of the pump.

14. The fuel vapor management system of claim 11, further comprising an evaporative emissions control system configured to recapture and recycle emitted fuel vapor on the fuel tank, the evaporative emissions control system comprising:
at least one vent tube disposed in the fuel tank;
at least one vent valve disposed on the at least one vent tube that is configured to selectively open and close at least one port fluidly coupled to the at least one vent tube;
a vent shut-off assembly that selectively opens and closes the at least one valve to provide overpressure and vacuum relief for the fuel tank; and
a control module that regulates operation of the vent shut-off assembly based on operating conditions.

15. The fuel vapor management system of claim 11, further comprising an evaporative emissions control system configured to recapture and recycle emitted fuel vapor on the fuel tank, the evaporative emissions control system comprising:
a first vent tube disposed in the fuel tank;
a second vent tube disposed in the fuel tank;
a first vent valve disposed on the first vent tube that is configured to selectively open and close a first port fluidly coupled to the first vent tube;
a second vent valve disposed on the second vent tube that is configured to selectively open and close a second port fluidly coupled to the second vent tube;
a vent shut-off assembly that selectively opens and closes the first and second valves to provide overpressure and vacuum relief for the fuel tank; and
a control module that regulates operation of the vent shut-off assembly based on operating conditions.

16. The fuel vapor management system of claim 15, wherein the vent shut-off assembly comprises a cam assembly having a cam shaft that includes a first cam and a second cam.

17. The fuel vapor management system of claim 16, wherein the first and second cams have respective profiles that correspond to at least a fully opened valve position, a fully closed valve position, and a partially open valve position.

18. The fuel vapor management system of claim 17, wherein the first and second vent valves are caused to selectively open and close based on rotation of the respective first and second cams to deliver fuel vapor through the respective first and second vent tubes.

19. The fuel vapor management system of claim 18, further comprising an actuator assembly that drives the cam assembly, the actuator assembly including a motor.

20. The fuel vapor management system of claim 19, wherein the motor comprises a direct current motor that rotates a worm gear that in turn drives a drive gear coupled to the cam shaft.

21. The fuel vapor management system of claim 11, further comprising an evaporative emissions control system configured to recapture and recycle emitted fuel vapor, the evaporative emissions control system comprising:
at least one vent valve configured to selectively open and close at least one vent;
a pressure sensor configured to sense a pressure in the fuel tank; and
a control module configured to regulate operation of the at least one vent valve to provide over-pressure and vacuum relief for the fuel tank, the control module programmed to periodically monitor the pressure in the fuel tank, wherein future control of the at least one vent valve is based on differences in the measured fuel tank pressure and the liquid level.

22. The fuel vapor management system of claim 11, further comprising an evaporative emissions control system configured to recapture and recycle emitted fuel vapor, the evaporative emissions control system comprising:
a first vent valve configured to selectively open and close a first vent;
a second vent valve configured to selectively open and close a second vent;
a pressure sensor configured to sense a pressure in the fuel tank; and
a control module configured to regulate operation of the first and second vent valves to provide over-pressure and vacuum relief for the fuel tank, the control module programmed to periodically monitor the pressure in the fuel tank, wherein future control of the first and second vent valves is based on differences in the measured fuel tank pressure and the liquid level.
